(19) United States
(12) Patent Application Publication
(10) Pub. No.: US 2016/0323901 A1
(43) Pub. Date: Nov. 3, 2016

(54) METHOD FOR CHANNEL MEASUREMENT AND REPORT IN WIRELESS COMMUNICATION SYSTEM AND APPARATUS THEREFOR

(71) Applicant: LG ELECTRONICS INC., Seoul (KR)

(72) Inventors: Kunil YUM, Seoul (KR); Yunjung YI, Seoul (KR); Kijun KIM, Seoul (KR)

(73) Assignee: LG ELECTRONICS INC., Seoul (KR)

(21) Appl. No.: 15/143,319

(22) Filed: Apr. 29, 2016

Related U.S. Application Data
(60) Provisional application No. 62/155,487, filed on May 1, 2015.

(51) Int. Cl. H04W 72/08; H04L 5/00; H04B 7/04; H04W 72/04

(52) U.S. Cl. CPC H04W 72/085; H04W 72/0413; H04L 5/0023; H04B 7/0417

(57) ABSTRACT

A method for channel measurement and report, performed by a mobile terminal operating while retuning to a plurality of narrowbands, in a wireless communication system, according to an embodiment of the present invention includes: receiving a channel state information (CSI) feedback configuration for a control channel and a data channel from a serving base station; measuring CSI for the control channel and CSI for the data channel according to the CSI feedback configuration; reporting the measured CSI to the serving base station; and receiving narrowband indication information for the mobile terminal from the serving base station, the narrowband indication information being determined based on the measured CSI, wherein the CSI feedback configuration includes a CSI reference resource for the control channel and a CSI reference resource for the data channel, the CSI reference resources being set independently of each other, wherein each of the CSI reference resources is comprised of a narrowband or a narrowband group including one or more narrowbands.

### CROSS-REFERENCE TO RELATED APPLICATION

Pursuant to 35 U.S.C. §119(e), this application claims the benefit of U.S. Provisional Application No. 62/155,487, filed on May 1, 2015, the contents of which are hereby incorporated by reference herein in its entirety.

### BACKGROUND OF THE INVENTION

1. Field of the Invention

The present invention relates to a wireless communication system and, more specifically, to a method for channel measurement and report and an apparatus therefor.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

According to an aspect of the present invention, there is provided a method for channel measurement and report, performed by a mobile terminal operating while retuning to a plurality of narrowbands, in a wireless communication system, including: receiving a channel state information (CSI) feedback configuration for a control channel and a data channel from a serving base station; measuring CSI for the control channel and CSI for the data channel according to the CSI feedback configuration; reporting the measured CSI to the serving base station; and receiving narrowband indication information for the mobile terminal from the serving base station, the narrowband indication information being determined based on the measured CSI, wherein the CSI feedback configuration includes a CSI reference resource for the control channel and a CSI reference resource for the data channel, the CSI reference resources being set independently of each other, wherein each of the CSI reference resources is comprised of a narrowband or a narrowband group including one or more narrowbands.

Alternatively or additionally, the mobile terminal may receive the control channel in a plurality of narrowbands by hopping the narrowbands and receive the data channel in a fixed narrowband.

Alternatively or additionally, the CSI reference resource for the control channel may include a plurality of narrowbands between which the mobile terminal hops.

Alternatively or additionally, the CSI reference resource for the data channel may include a fixed narrowband.

Alternatively or additionally, the measured CSI for the control channel may be periodically reported and the measured CSI for the data channel may be aperiodically reported.

Alternatively or additionally, the CSI for the control channel may be measured in all narrowbands monitored by the mobile terminal.

Alternatively or additionally, the CSI for the control channel may be measured in a narrowband in which the control channel is received.

Alternatively or additionally, the CSI for the control channel may be measured in the entire system bandwidth.

According to an aspect of the present invention, there is provided a mobile terminal configured to perform channel measurement and report and operating while retuning to a plurality of narrowbands in a wireless communication system, including: a radio frequency (RF) unit; and a processor configured to control the RF unit, wherein the processor is configured to receive a CSI feedback configuration for a control channel and a data channel from a serving based station, to measure CSI for the control channel and CSI for the data channel according to the CSI feedback configuration, to report the measured CSI to the serving base station and to receive narrowband indication information for the mobile terminal from the serving base station, the narrowband indication information being determined on the basis of the measured CSI, wherein the CSI feedback configuration includes a CSI reference resource for the control channel and a CSI reference resource for the data channel, the CSI reference resources being set independently of each other, wherein each of the CSI reference resources is comprised of a narrowband or a narrowband group including one or more narrowbands.

Alternatively or additionally, the processor may be configured to receive the control channel in a plurality of narrowbands by hopping between the naarowbands and to receive the data channel in a fixed narrowband.

Alternatively or additionally, the CSI reference resource for the control channel may include a plurality of narrowbands between which the mobile terminal hops.

Alternatively or additionally, the CSI reference resource for the data channel may include a fixed narrowband.

Alternatively or additionally, the measured CSI for the control channel may be periodically reported and the measured CSI for the data channel may be aperiodically reported.

Alternatively or additionally, the CSI for the control channel may be measured in all narrowbands monitored by the mobile terminal.

Alternatively or additionally, the CSI for the control channel may be measured in a narrowband in which the control channel is received.

Alternatively or additionally, the CSI for the control channel may be measured in the entire system bandwidth.

The aforementioned technical solutions are merely parts of embodiments of the present invention and various embodiments in which the technical features of the present invention are reflected can be derived and understood by a person skilled in the art on the basis of the following detailed description of the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an exemplary radio frame structure used in a wireless communication system;

FIG. 2 illustrates an exemplary downlink/uplink (DL/UL) slot structure used in a wireless communication system;

FIG. 3 illustrates a DL subframe structure used in 3GPP LTE/LTE-A;

FIG. 4 illustrates a DL subframe structure used in 3GPP LTE/LTE-A;

FIG. 5 illustrates a configuration of a narrowband group according to an embodiment of the present invention;

FIG. 6 is a flowchart illustrating an operation according to an embodiment of the present invention; and

FIG. 7 is a block diagram of an apparatus for implementing embodiments of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

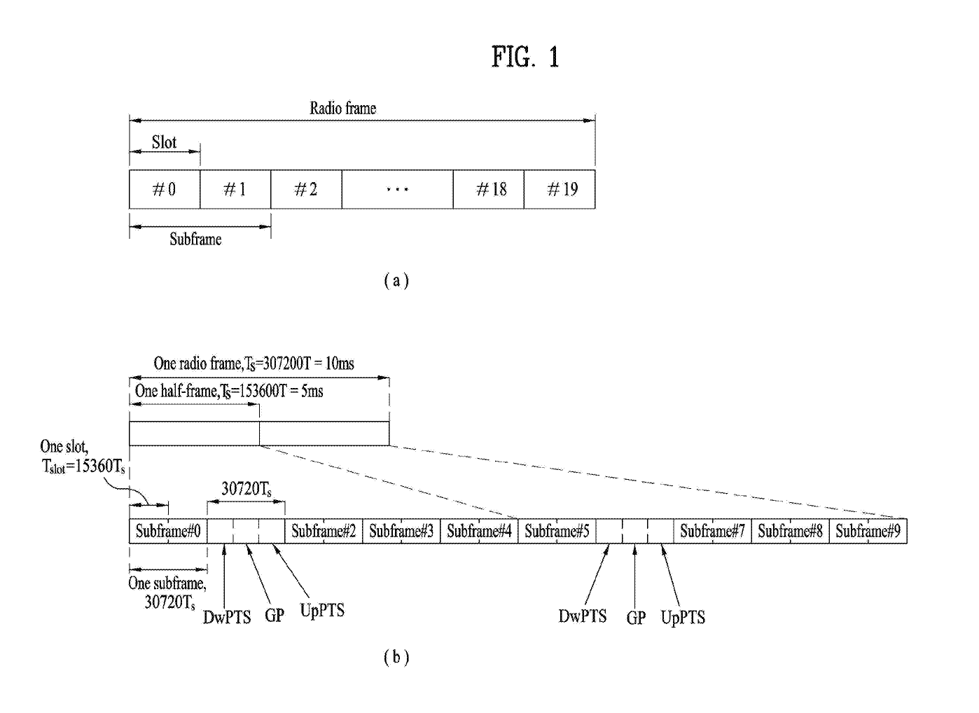

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of lms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

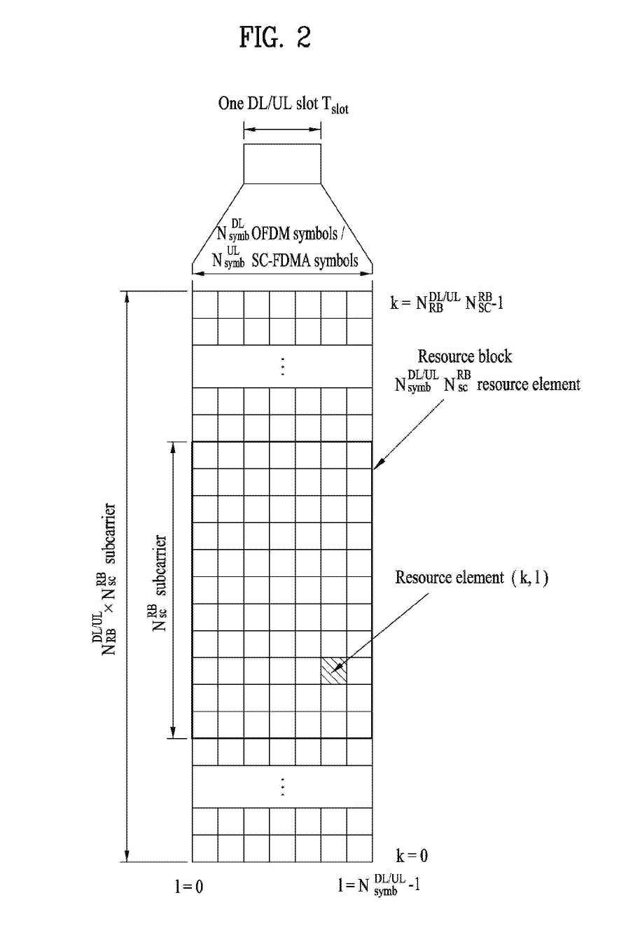

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

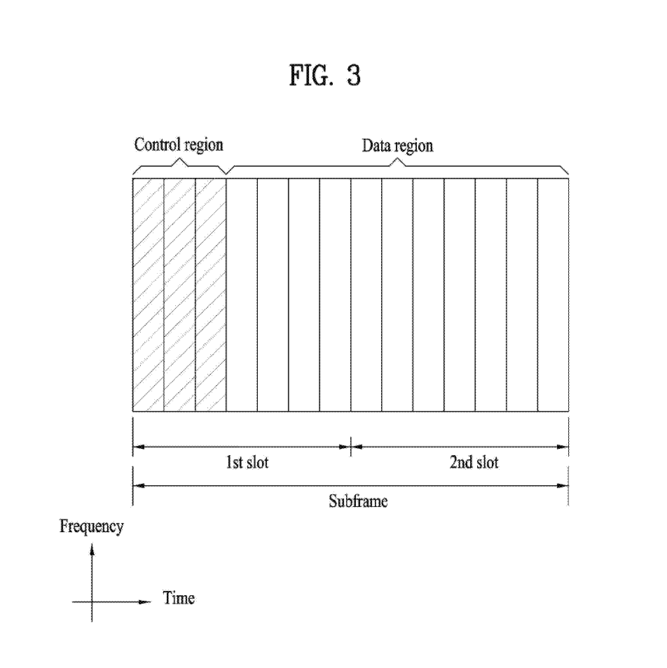

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| | | | Number |
|---|---|---|---|
| Search Space | | | of PDCCH |
| Type | Aggregation Level L | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

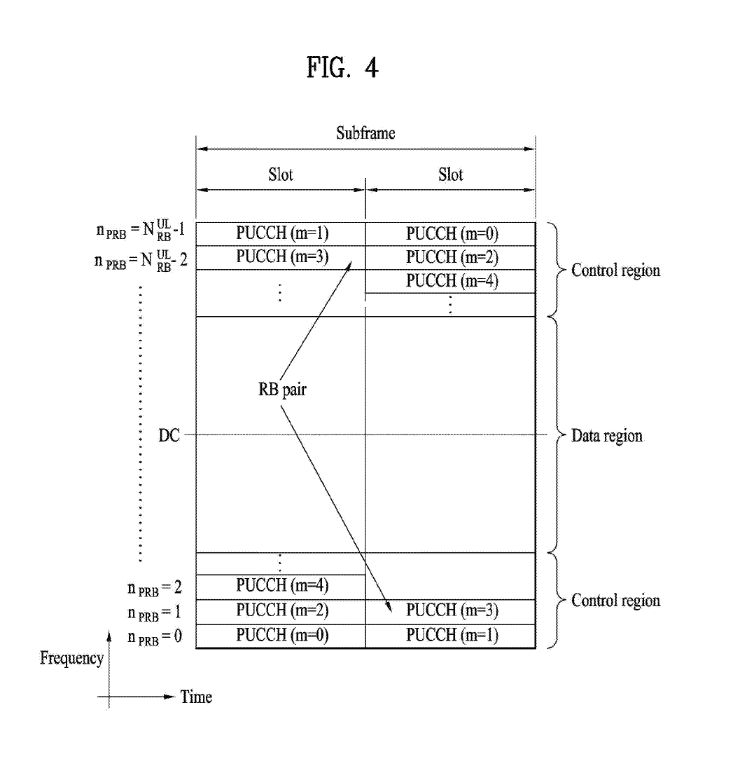

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One codeword |
| | | | SR + ACK/NACK | |
| 1b | QPSK | 2 | ACK/NACK or | Two codeword |
| | | | SR + ACK/NACK | |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/ | |
| | | | NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMI/RI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

Next-generation systems such as LTE-A consider configuration of inexpensive/low-specification UEs for data communication, such as metering, water level measurement, monitoring camera utilization and vending machine inventory reporting. In the case of such UEs, the quantity of transmitted data is small and uplink/downlink data transmission/reception are not frequently performed, and thus it is effective to reduce UE costs and decrease battery consumption on the basis of a low data transfer rate. Accordingly, a scheme in which the aforementioned UEs can use up to 6 RBs irrespective of system bandwidth is considered. However, such scheme may deteriorate performance. Therefore, it is necessary to newly consider a narrowband configuration scheme and time allocation for measurement of other channels. Furthermore, hopping of narrowbands of some channels is considered in order to compensate for deteriorated performance. In this case, measurement schemes need to be separately set for respective channels.

Narrowband Trouping

Since a UE can see only a narrowband of N RBs (e.g. 6 RBs) per timing, system bandwidth can be divided into narrowbands each corresponding to N RBs. That is, if the system bandwidth is M RBs, a total of K narrowbands (K=┌M/N┐) may exist. On the assumption that an eNB does not use the entire system bandwidth for certain reasons, K can be less than the number of narrowbands that can be actually set to the system bandwidth. For example, when an offset is applied to N RBs and thus only M−offset RB (N_{offset}^{RB}) is used, K=|M−N_{offset}^{RB}/N|. When the eNB sends a request for CSI about subbands to the UE, the UE can measure K narrowbands instead of the subband. If UE capability or payload is limited to N−k (k>0) when the UE measures the K narrowbands, a problem may be generated. When the eNB directly indicates indices of the K narrowbands to the UE in order to receive CSI about a specific narrowband through an aperiodic CSI request, overhead may increase. In this case, it may be useful to combine the narrowband indices. Considering that the number of results of measurement of the K narrowbands increases, periodic CSI reporting may increase reporting overhead. In addition, when UE mobility is not high, it may be inefficient to send feedbacks of all subbands since pieces of CSI about neighboring narrowbands may not have a large difference therebetween.

While a subband used in LTE and a narrowband used in the specification may have different structures, subband CSI will be regarded as narrowband CSI in the following description for convenience.

Narrowbands can be grouped as follows.

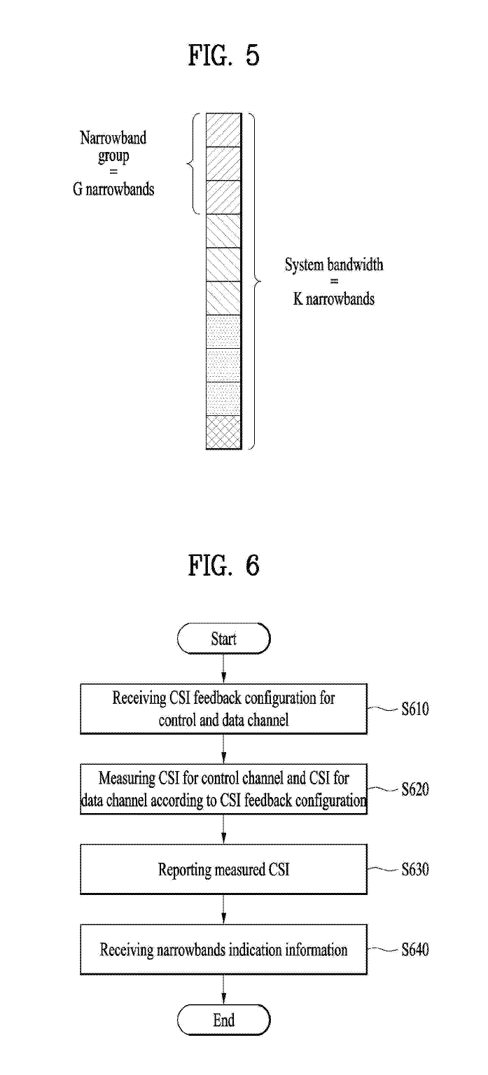

A narrowband group may include G consecutive narrowbands. In this case, a total of ┌K/G┐ narrowband groups exist. The narrowband group size G may be designated through RRC signaling or set by a table predefined according to system bandwidth. A narrowband group may be given as a subset of all narrowbands/subbands. This may be effective when frequency or narrowband resources are restricted for a wideband CQI. For example, when a network wants to select one of pattern 1 using subbands 1, 4, 7 and 10 and pattern 2 using subbands 2, 5, 8 and 11, the network can group the subbands and enable CSI feedback for each group to be transmitted thereto. This may be useful when the network adjusts power for frequencies by performing ICIC (inter cell interference coordination) or FE (further enhanced) ICIC with a neighboring cell and thus effective frequencies are restricted. In addition, an embodiment of the present invention proposes restriction of a CSI reference resource per set narrowband group. That is, when a narrowband is set to a UE for CSI measurement, a reference resource is limited within the narrowband group such that signal power or interference cannot be used in a subband belonging to the narrowband group. FIG. 5 illustrates an example when G=3 and K=10. That is, a system bandwidth composed of 10 narrowbands can have a total of ┌10/3┐=4 narrowband groups. The UE can measure or transmit CSI per narrow group using a method such as subband CSI reporting. The following methods can be used.

Method of Measuring or Transmitting a Channel with Respect to a Predetermined Narrowband from Among Narrowbands in a Narrowband Group

This method can be performed on the assumption that pieces of CSI of narrowbands in the corresponding narrowband group are similar, such as a case in which the narrowband group is within a coherent bandwidth. A narrowband whose CSI is measured may be predefined or designated by the eNB for the UE through RRC signaling. In this case, the UE need not additionally transmit the index of the narrowband. In addition, overhead can be reduced since channel measurement can be performed only once per narrowband group.

Method of Selecting a Narrowband in a Narrowband Group and Measuring or Transmitting a Channel with Respect to the Selected Narrowband by a UE

While this method is similar to the aforementioned method, a narrowband whose CSI is measured is not predefined or designated. This method can be performed on the assumption that pieces of CSI of narrowbands in the corresponding narrowband group are similar, as described above. The UE transmits a result of measurement of a channel with respect to an arbitrary narrowband in the narrowband group and does not transmit information (e.g. narrowband index) about a narrowband for which channel measurement has been performed. Since a large channel measurement value difference may be present between narrowbands in the narrowband group, narrowband index transmission overhead is not large if the narrowband group size is not large. Accordingly, it is possible to transmit the narrowband index along with the channel measurement result.

Method of Measuring or Transmitting a Result with Respect to a Narrowband Designated by the eNB from Among the Narrowbands in the Narrowband Group

The eNB designates a narrowband to be measured in a narrowband group for a UE and the UE measures a channel with respect to the narrowband and transmits a measurement result. In this case, for measurement of a CQI of a specific narrowband group, the eNB can designate the narrowband group for the UE as follows.

When an aperiodic CSI request is triggered for the UE, as shown in the following table, corresponding triggering information can indicate the narrowband group corresponding to a measurement and report target.

TABLE 5

| Value | |
|---|---|
| of CSI request field | Description |
| ‘00’ | No aperiodic CSI report is triggered |
| ‘01’ | Aperiodic CSI report is triggered for all |
| | narrowband groups for serving cell^{c} |
| ‘10’ | Aperiodic CSI report is triggered for a 1st set |
| | of narrowband groups configured by higher |
| | layers for serving cell^{c} |
| ‘11’ | Aperiodic CSI report is triggered for a 2nd set |
| | of narrowband groups configured by higher |
| | layers for serving cell^{c} |

The narrowband group may be set to the UE through higher layer signaling such as RRC signaling.

Alternatively, a measurement result about the narrowband group may be transmitted by setting a new container included in DCI.

Such signaling methods may be used for other channel measurement methods. Furthermore, the signaling methods may be used to indicate narrowband group subsets.

Method of Transmitting a Channel with Respect to Best One Narrowband from Among Narrowbands in a Narrowband Group Along with the Corresponding Narrowband Index

A UE can transmit information on a channel with respect to best one narrowband along with the index of the narrowband measured thereby in the group.

The eNB instructs the UE to perform hopping per narrowband group using the aforementioned channel measurement method and determine which narrowband in a narrowband group will be used with reference to scheduling information of other UEs and channel information of narrowbands in the narrowband group.

In addition, signal power may be averaged between narrowbands according to method of measuring a narrowband channel in a narrowband group. For example, when the UE randomly selects a narrowband in the aforementioned narrowband group, it can be assumed that the UE can average any signal powers among L narrowbands in the narrowband group in order to reduce frequency retuning overhead and UE burden. This can be interpreted as meaning that the UE can perform monitoring in any narrowband which is a subframe valid as a reference subframe for a CQI and belongs to the narrowband group.

When narrowband groups are configured, the UE assumes a CSI reference resource to belong to only one narrowband group. In addition, it is assumed that the UE is not triggered to measure CSI about narrowbands that do not belong to the narrowband groups.

The CSI reference resource according to 3GPP TS 36.213 is defined as follows.

Based on an unrestricted observation interval in time and frequency, the UE shall derive for each CQI value reported in uplink subframe n the highest CQI index between 1 and 15 which satisfies the following condition, or CQI index 0 if CQI index 1 does not satisfy the condition:

A single PDSCH transport block with a combination of modulation scheme and transport block size corresponding to the CQI index, and occupying a group of downlink physical resource blocks termed the CSI reference resource, could be received with a transport block error probability not exceeding 0.1.

Unrestricted observation of the UE by monitoring narrowbands may affect accuracy and overhead. Accordingly, the definition of the CSI reference resource can be modified as follows when the reference resource is limited to narrowband groups proposed by the present invention.

Based on an unrestricted observation interval in time but restricted frequency locations defined by narrowband group, the UE shall derive for each CQI value reported in uplink subframe n the highest CQI index between 1 and 15 which satisfies the following condition, or CQI index 0 if CQI index 1 does not satisfy the condition:

A single PDSCH transport block with a combination of modulation scheme, repetition number or level and transport block size corresponding to the CQI index, and occupying a group of downlink physical resource blocks (within one narrowband) termed the CSI reference resource, could be received with a transport block error probability not exceeding 0.1.

In other words, since a CSI reference resource may exceed PRBs to which a PDSCH can be mapped, the CSI reference resource needs to be assumed to be one narrowband (e.g. 6 PRBs) in CQI calculation. Accordingly, the CSI reference resource may exceed a region to which the PDSCH can be mapped. Furthermore, considering a case in which a repetition number is applied to CQI calculation, CQI calculation may be changed to a method of calculating spectral efficiency in consideration of the repetition number in the conventional scheme of calculating a CQI with an MCS/TBS.

The definition of the CSI reference resource in frequency can be modified as follows when narrowband groups are used. That is, subband measurement is performed for all narrowband groups.

The CSI reference resource for a serving cell is defined as follows:

In the frequency domain, the CSI reference resource is defined by the group of downlink physical resource blocks corresponding to the narrowband group to which the derived CQI value relates.

The above interpretation can be equally applied to a case in which narrowband grouping for interference measurement is applied. Alternatively, while the CSI reference resource is fixed to one narrowband/subband, interference may be measured in a narrowband group.

When such narrowband grouping method is not used, the CSI reference resource refers to a resource corresponding to each subband/narrowband in a valid downlink subframe when a CSI subframe set is not configured. More particularly, such resource setting method is applied only to subband CQI/CSI measurement and report and, in the case of wideband CQI/CSI, the CSI reference resource may refer to the entire system bandwidth, a set of narrowbands in which control channels can be received or a designated subband/narrowband set. If a subframe set is configured, the CSI reference resource may be limited to the time domain.

In addition to the aforementioned channel measurement method, a method of transmitting average channel information within a narrowband group may be used unless selection of a subband in a narrowband group or channel measurement is considered. In this case, the eNB can schedule the UE in a narrowband within a narrowband group on the assumption that the channel of the UE is identical in the narrowband group.

The narrowband group can be set in terms of interference measurement. In this case, the following can be considered.

The UE can average interference in the narrowband group.

When the UE performs interference measurement, the UE collects results of measurements performed in a plurality of RBs, in general, for accuracy. When the UE measures an SINR (i.e. CQI) per narrowband in the narrowband group, the UE derives a more accurate SINR (i.e. CQI) using interference measured in the narrowband group instead of interference measured only in the corresponding narrowband. In addition, the UE may average interferences measured in narrowbands belonging to the narrowband group and use the averaged interference in order to increase the number of subframes for which interference can be measured within a predetermined time. To this end, the eNB can set the narrowband group and enable the UE to derive interference using an interference value measured in a corresponding period.

Narrowband Groups Assumed to have Identical Interference

When the UE performs interference measurement in a narrowband, if an interference measurement result for a narrowband in the same narrowband group is present even if the narrowband is not the corresponding narrowband, the UE can use the measured interference measurement result of the narrowband without performing interference measurement.

When such narrowband groups are configured and the UE measures interference corresponding to one subband, the UE can use only a frequency/time resource (CSI reference resource) corresponding to a narrowband/subband in a narrowband group to which the corresponding narrowband/subband belongs.

The aforementioned narrowband grouping and channel measurement according thereto can be applied to both aperiodic channel measurement and periodic channel measurement.

When such a narrowband group is configured, the UE may not perform reporting and measurement for a subband that does not belong to the narrowband group. If the narrowband group is not configured or a subband subset is not configured for measurement, the UE may not perform subband measurement.

Separated CSI Reports for a Control Channel and a Data Channel

MTC scenarios assume a situation in which a control channel and a data channel are transmitted in different environments in such a manner that transmission timing of the control channel is separated from transmission timing of the data channel. In this case, transmission schemes can be set differently for the control channel and the data channel. For example, the control channel and the data channel can be transmitted in different narrowbands. Particularly, a case in which the control channel uses hopping, whereas the data channel does not use hopping may be considered.

In this case, CSI measurement and reporting schemes need to be separately set for the respective cases.

Wideband CSI is Used for a Control Channel, Whereas Subband CSI is Used for a Data Channel

For example, CSI of the control channel can be set to wideband CSI and CSI of the data channel can be set to subband CSI. While this is because a scenario in which the control channel is transmitted using narrowband hopping and the data channel is transmitted using a specific narrowband is assumed, this is applicable to other scenarios. A UE measures wideband CSI in the control channel, transmits an averaged CQI using measurement channels between hopping narrowbands, measures a channel with respect to a narrowband (or narrowband group) designated by the eNB in the data channel and transmits the result of channel measurement such that the eNB indicates a narrowband for the UE. To this end, the eNB needs to separately designate a narrowband for a wideband (control channel) to be measured and a narrowband for a subband (data channel). Here, a narrowband (group) set for the narrowband for the wideband (control channel) can be used as a hopping narrowband pattern to be used by the control channel. The hopping narrowband pattern can be used when the control channel performs narrowband hopping. Alternatively, the network can set the subband/narrowband set. A narrowband set for the wideband can be set, similarly to a CSI subframe set, and a plurality of narrowband sets can be set. When such narrowband sets are configured, narrowbands belonging to each set can be grouped into one CSI reference resource.

To this end, feedback mode 2-1 of LTE can be reused. In this case, the eNB can designate a narrowband group instead of a bandwidth part and the UE can perform narrowband channel measurement in the narrowband group. That is, the UE can transmit the uppermost narrowband index in the designated narrowband group and the corresponding CQI.

Only a Data Channel is Used in Aperiodic Reporting and Only a Control Channel is Used in Periodic Reporting

According to another embodiment of the present invention, a control channel reporting scheme and a data channel reporting scheme can be separated from each other. In this case, aperiodic reporting and periodic reporting may require designation of different narrowbands. For example, in the case of channel measurement for a data channel, a narrowband for channel measurement of a UE can be signaled by designating a narrowband (group) through an aperiodic CSI request, as shown in Table 5.

However, when data transmission uses a narrowband different from a control channel, periodic CSI about a data transmission interval is meaningless and thus aperiodic CSI reporting may be activated or deactivated (on/off) as necessary. That is, periodic CSI reporting can defined such that the periodic CSI reporting is activated or deactivated in a control channel transmission interval or a data channel transmission interval. Otherwise, period CSI reporting may be directly activated or deactivated through a method using DCI.

More specifically, when the control channel reporting scheme and the data channel reporting scheme are separated from each other, in the case of a subband fed back through aperiodic reporting, the CSI reference resource can become each subband/narrowband. In the case of a subband fed back through periodic reporting, the CSI reference resource can correspond to the entire system bandwidth, a set of subbands/narrowbands or a subband/narrowband set in which control channels are monitored.

CSI for a Control Channel and CSI for a Data Channel are Separately Transmitted in Different Transmission Instances of Periodic Reporting

When CSI for a control channel and CSI for a data channel are transmitted at different timings, a UE can respectively transmit different pieces of CSI in a reporting interval for the control channel and a reporting interval for the data channel. In this case, narrowband group measurement for allocating a narrowband to the UE can use aperiodic CSI.

When data is transmitted in a narrowband belonging to a hopping narrowband pattern or set, narrowband CSI that can be obtained during measurement of control channel CSI can be used as data channel CSI. In this case, a process for allocating a narrowband to the UE can be omitted.

In this case, however, channels measured in a region corresponding to the control channel need to be averaged when the average CQI is calculated. If the start and end of control channel transmission are predefined and known, CQI averaging can be performed only on the corresponding part. Alternatively, the start and end points of the control channel can be signaled through a method such as DCI such that CQI averaging can be performed only on the corresponding part.

For the aforementioned case, channel measurement for the control channel and channel measurement for the data channel need to be differently set. Accordingly, different CSI process application schemes can be considered for the two cases.

Narrowbands (Narrowband Groups) for Measurement of a Control Channel and a Data Channel are Separately Set to One CSI Process

In a CSI process for a control channel and a data channel, narrowbands (narrowband groups), hopping and periodic/aperiodic CSI reporting may be differently set for the control channel and the data channel.

Control Channel Measurement and Data Channel Measurement are Set to Different CSI Processes

When periodic CSI and aperiodic CSI are respectively allocated to a control channel and a data channel, aperiodic CSI reporting for a CSI process for the data channel may be performed at an aperiodic CSI request without additional signaling by setting the CSI with respect to the control channel to “aperiodic off”. For the same purpose, the two CSI processes may be paired such that the CSI processes for the control channel/data channel can be used in the case of periodic/aperiodic reporting.

For example, CSI transmission can be arranged as follows.

TABLE 6

| | Periodic | Aperiodic |
|---|---|---|
| | CSI reporting | CSI reporting |
| Scheduling Mode | channels | channel |
| Frequency non-selective (control | PUCCH | PUSCH |
| channel or data channel) | | |
| Frequency selective (data channel) | PUCCH | PUSCH |

In other words, when a transmission/scheduling mode in which a subband is selected on the basis of CSI about subbands and scheduled is used for a data channel, the UE is expected to report multiple subbands based on aperiodic CSI. Otherwise, round-robin feedback through a PUCCH may be reported or only a report on a wideband CQI may be present. When the PUCCH needs to be repeatedly transmitted through coverage enhancement, it is difficult to perform overhead and periodic repetitive transmission scheduling. In this case, a mode in which only wideband CQIs are transmitted through aperiodic CSI can be supported.

When an aperiodic CSI request field is 1 bit, “0” can indicate a wideband CQI and “1” can indicate all set subbands. If 2 bits are used for the aperiodic CSI request field, aperiodic CSI report can be set as shown in the following table.

TABLE 7

| Value of CSI request field | Description |
|---|---|
| ‘00’ | No aperiodic CSI report is triggered |
| ‘01’ | Aperiodic CSI report is triggered for |
| | wideband CQI |
| ‘10’ | Aperiodic CSI report is triggered for a 1st |
| | set of narrowband groups (or narrowbands) |
| | configured by higher layers for serving cell^{c} |
| ‘11’ | Aperiodic CSI report is triggered for a 2nd |
| | set of narrowband groups (or narrowbands) |
| | configured by higher layers for serving cell^{c} |

The second set may be all narrowband groups or all set narrowband sets. When the second set is not set, the UE can transmit subband reports on all narrowband groups or narrowbands upon reception of “11”.

A low-power MTC UE may not report an RI. However, the UE may still be requested to report a PMI. A subband set for which reporting on a PMI is requested may be identical to a subband set for which a CQI will be calculated or may be independently set. The subband set is desirably a subset of the CQI subband set even though the subband set is independent. Definition of a single PMI can consider the following operations, similarly to the wideband CQI.
Definition of a single PMI may mean PMI calculation through averaging by assuming all subbands/narrowbands that can be monitored by the UE as a valid CSI reference resource.
Definition of a single PMI may mean PMI calculation through averaging by assuming subbands/narrowbands in which all USS control channels monitored by the UE are received as a valid CSI reference resource.
Definition of a single PMI may mean derivation of a PMI by the UE through averaging over the entire system bandwidth through a measurement gap.

In addition to the above definition of a single PMI, definition of a wideband CQI may be extended in the form of a “single CQI” as follows.
Definition of a single CQI may mean CQI calculation through averaging by assuming all subbands/narrowbands that can be monitored by the UE as a valid CSI reference resource.
Definition of a single CQI may mean CQI calculation through averaging by assuming subbands/narrowbands in which all USS control channels monitored by the UE are received as a valid CSI reference resource.
Definition of a single CQI may mean derivation of a CQI by the UE through averaging over the entire system bandwidth through a measurement gap.

When an average CQI in a narrowband group is calculated and transmitted, a PMI of each narrowband in the narrowband group can be calculated or transmitted. When a single CQI in the narrowband group is calculated and transmitted, an average PMI in the narrowband group can be calculated or transmitted.

In the respective cases, the bandwidth and the number of RBs for PMI calculation may be changed. Furthermore, a codebook subset may be further restricted in consideration of overhead of low-power UEs.

In the case of an aperiodic CSI request, a UE is not expected to receive another aperiodic CSI request before CSI report is ended. For example, when the number of repetitions of PUCCH transmission is 100 and an M-PDCCH is repeatedly transmitted 10 times, another aperiodic CSI request is not expected to be received during repeated PUCCH transmission. That is, in the case of an MTC UE, CSI processes that need to be performed can be limited to one at a time. Even if the UE receives one or more aperiodic CSI requests, the UE may perform CSI reporting on one request and may not update other CSI.

In addition, the UE can report the number of CSI processes that can be performed thereby to the network or the eNB. In this case, the UE may not update requests exceeding the number of CSI processes within the capability thereof. CSI report can be processed according to a rule of PUSCH overlap handling.

Measurement Gap

Since a UE can use only N RBs (e.g. 6 RBs) at one timing, a scheme of providing an interval in which data is not transmitted, such as a measurement gap, such that the UE moves to a narrowband and measures a channel therein during the interval is needed in order for the UE to measure the channel of the narrowband.

Three channels, radio resource management (RRM), a control channel and a data channel, are expected to be measured by the UE in the measurement gap. Accordingly, the measurement gap needs to be set in the following three cases.

Measurement Gaps are Respectively Set for Measurement of the Channels.

When separate measurement gaps are set for the respective cases, measurement of each channel is not restricted but excessive overhead due to many measurement gaps is expected.
A measurement gap is set with measurement priority such that only measurement with higher priority is performed when two or more measurement timings overlap at specific timing.
Measurement gaps having different sizes are set, and a large measurement gap is set for a corresponding reporting opportunity when two or more measurements (e.g. RRM and data channel measurement) are required such that the measurements can share the corresponding measurement gap.
One measurement gap is shared.

One measurement gap is set and used in all cases. When the size of the measurement gap is not dynamically set, a large measurement gap needs to be operated and thus large overhead is expected.

When different measurement gaps are set, a measurement gap having a long period and long duration can be set for CSI. Since it is desirable to perform measurement immediately before transmission of aperiodic trigger, the measurement gap may be operated with a DRX (discontinuous reception) operation of the UE. For example, when the UE is set to DRX ON, the measurement gap can support operation of the UE to measure and transmit CSI about a subband set therefor. This operation can be performed without a separate measurement gap. To this end, the UE may need to perform measurement a predetermined time in advance of setting to DRX ON. CQI measurement therefor may be triggered by the network through an aperiodic CSI request as necessary.

In addition, a certain channel can be measured without a measurement gap during channel measurement. For example, the UE can directly measure a control channel while performing narrowband hopping. In this case, measurement gaps for RRM and data channels can be set according to the aforementioned scheme.

Measurement RS

Repeated transmission of a CSI-RS to a UE in a coverage enhancement mode may cause problems in spectral efficiency and overhead when existing UEs are considered. To solve such problems, transmission mode (TM) 9 or a TM equivalent thereto has been set for the UE and the UE may not expect the CSI-RS even when PMI-RI report has been activated. Although the UE may be provided with configurations of a CSI-RS and a zero-power CSI-RS for data rate matching, it can be assumed that the CSI-RS is not used for coverage enhancement. In this case, the UE can perform measurement using a CRS or a DM-RS.

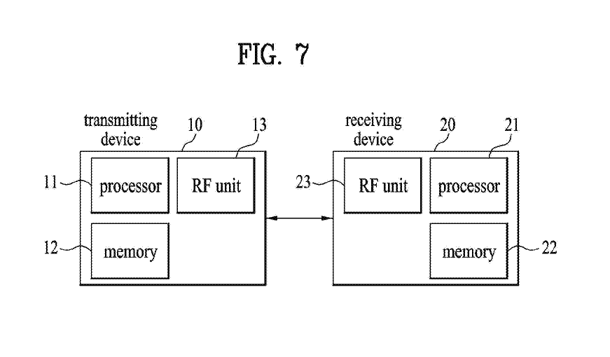

FIG. 6 illustrates an operation according to an embodiment of the present invention.

FIG. 6 shows a method for channel measurement and report in a wireless communication system. The method can be performed by a UE that operates while retuning to a plurality of narrowbands.

The UE may receive a CSI feedback configuration for a control channel and a data channel from a serving eNB (S610). The UE may measure CSI for the control channel and CSI for the data channel according to the CSI feedback configuration (S620). Then, the UE may report the measured CSI to the serving eNB (S630). The UE may receive narrowband indication information therefor, which is determined on the basis of the measured CSI, from the serving eNB (S640).

The CSI feedback configuration may include a CSI reference resource for the control channel and a CSI reference resource for the data channel, which are set independently of each other, and each CSI reference resource may be composed of a narrowband or a narrowband group including one or more narrowbands.

The UE may receive the control channel while hopping between a plurality of narrowbands and receive the data channel in a fixed narrowband.

The CSI reference resource for the control channel may include a plurality of narrowbands through which the UE hops. The CSI reference resource for the data channel may include a fixed narrowband.

In addition, the CSI for the control channel may be periodically reported and the CSI for the data channel may be aperiodically reported.

The CSI for the control channel may be measured in all narrowbands that can be monitored by the UE. The CSI for the control channel may be measured in a narrowband in which the control channel is received. The CSI for the control channel may be measured in the entire system bandwidth.

While an embodiment of the present invention has been described with reference to FIG. 6, the embodiment may alternatively or additionally include at least part of the aforementioned embodiments.

What is claimed is:

1. A method for channel measurement and report, performed by a mobile terminal operating while retuning to a plurality of narrowbands, in a wireless communication system, the method comprising:
receiving a channel state information (CSI) feedback configuration for a control channel and a data channel from a serving base station;
measuring CSI for the control channel and CSI for the data channel according to the CSI feedback configuration;
reporting the measured CSI to the serving base station; and
receiving narrowband indication information for the mobile terminal from the serving base station, the narrowband indication information being determined based on the measured CSI,
wherein the CSI feedback configuration includes a CSI reference resource for the control channel and a CSI reference resource for the data channel, the CSI reference resources being set independently of each other,
wherein each of the CSI reference resources is comprised of a narrowband or a narrowband group including one or more narrowbands.

2. The method according to claim 1, wherein the mobile terminal receives the control channel in a plurality of narrowbands by hopping between the narrowbands and receives the data channel in a fixed narrowband.

3. The method according to claim 1, wherein the CSI reference resource for the control channel includes a plurality of narrowbands between which the mobile terminal hops.

4. The method according to claim 1, wherein the CSI reference resource for the data channel includes a fixed narrowband.

5. The method according to claim 1, wherein the measured CSI for the control channel is periodically reported and the measured CSI for the data channel is aperiodically reported.

6. The method according to claim 1, wherein the CSI for the control channel is measured in all narrowbands monitored by the mobile terminal.

7. The method according to claim 1, wherein the CSI for the control channel is measured in a narrowband in which the control channel is received.

8. The method according to claim 1, wherein the CSI for the control channel is measured in the entire system bandwidth.

9. A mobile terminal configured to perform channel measurement and report and operating while retuning to a plurality of narrowbands in a wireless communication system, the mobile terminal comprising:
a radio frequency (RF) unit; and
a processor configured to control the RF unit,
wherein the processor is configured to receive a CSI feedback configuration for a control channel and a data channel from a serving base station, to measure CSI for the control channel and CSI for the data channel according to the CSI feedback configuration, to report the measured CSI to the serving base station and to receive narrowband indication information for the mobile terminal from the serving base station, the narrowband indication information being determined based on the measured CSI,
wherein the CSI feedback configuration includes a CSI reference resource for the control channel and a CSI reference resource for the data channel, the CSI reference resources being set independently of each other,
wherein each of the CSI reference resources is comprised of a narrowband or a narrowband group including one or more narrowbands.

10. The mobile terminal according to claim 9, wherein the processor is configured to receive the control channel in a plurality of narrowbands by hopping between the narrowbands and to receive the data channel in a fixed narrowband.

11. The mobile terminal according to claim 9, wherein the CSI reference resource for the control channel includes a plurality of narrowbands between which the mobile terminal hops.

12. The mobile terminal according to claim 9, wherein the CSI reference resource for the data channel includes a fixed narrowband.

13. The mobile terminal according to claim 9, wherein the measured CSI for the control channel is periodically reported and the measured CSI for the data channel is aperiodically reported.

14. The mobile terminal according to claim 9, wherein the CSI for the control channel is measured in all narrowbands monitored by the mobile terminal.

15. The mobile terminal according to claim 9, wherein the CSI for the control channel is measured in a narrowband in which the control channel is received.

16. The mobile terminal according to claim 9, wherein the CSI for the control channel is measured in the entire system bandwidth.
